(19) United States
(12) Patent Application Publication
(10) Pub. No.: US 2007/0094740 A1
(43) Pub. Date: Apr. 26, 2007

(54) Document management apparatus and document management method

(75) Inventor: Takao Shudo, Kobe-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies Inc., Tokyo (JP)

(21) Appl. No.: 11/439,234

(22) Filed: May 24, 2006

(30) Foreign Application Priority Data
Oct. 26, 2005 (JP) 2005--311177

(51) Int. Cl. H04N 7/16; G06F 17/30; G06F 17/00

(52) U.S. Cl. 726/26; 707/9; 715/530

(57) ABSTRACT

To provide a document management apparatus capable of protecting documents including a document free of the control of the document management apparatus in accordance with a document mode without requiring any complicated user operation. The document management apparatus comprises a document management unit for managing a mode indicating a registration state of a registered document, a rule management unit for managing a rule restricting a function that can be executed by a user in relation to the document, a rule application unit for selecting the rule in accordance with the mode of the document, and an encryption unit for encrypting the document based on the rule.

This application is based on Japanese Patent Application No. 2005-311177 filed in Japan on Oct. 26, 2005, the contents of which are hereby incorporated by reference.

### BACKGROUND

1. Field of the Invention

The present invention relates to a document management apparatus and a document management method for controlling a user's access right with respect to a document.

2. Description of the Related Art

To be abreast with the development of an information device and the demand for a paperless environment promoted in an office and the like of recent years, a document management apparatus for fetching a document drawn up on a paper using a scanner and registering the fetched document on a personal computer, a server or the like as an image document has been widely used so as to realize a consolidated document management. Further, as an example of a complex apparatus including a printing function, a scanning function, a facsimile function and the like which has also been widespread, a document management function for storing the document is installed in the complex apparatus itself in order to deal with an increasingly larger capacity of a memory device such as a hard disc.

When the scanned document inputted via the complex apparatus including the scanner unit and an electronic document drawn up in an application software on the personal computer are registered in the document management apparatus, an access right for browsing, editing and the like is often previously set per document and per user in accordance with an attribute of the document so that any confidential information is not needlessly leaked or falsified by a third party.

An example of the foregoing apparatus is a document management apparatus that sets a security information indicating terms for allowing the disclosure of the document when the document is registered in the document management apparatus and provides an access right to the document for members/hierarchy/collective entity permitted to browse the document in accordance with the set information, as shown in Japanese Patent Laid-open Publication No. 2001-265636. Another example is an apparatus that acquires a confidentiality policy for the document from a management server and encrypts the document based on a certification specified by the acquired confidentiality policy, as shown in Japanese Patent Laid-open Publication No. 2004-151163.

### SUMMARY

However, in the case of the document management apparatus recited in Japanese Patent Laid-open Publication No. 2001-265636, the document management apparatus itself controls the permission/prohibition of the browse of the document registered therein. Therefore, when a user allowed to make a browse access copies the document and consequently releases the document from the control of the document management apparatus, the apparatus loses the control over the prohibition of the document browse. As a result, any user who is not permitted to access the document can browse the document, which may disadvantageously result in the leakage or the falsification of the confidential information. In the case of the document management apparatus recited in Japanese Patent Laid-open Publication No. 2004-151163, no one other than a predetermined user can undo the encryption even after the document is no longer controlled by the document management apparatus because the document is encrypted based on the certification specified by the confidentiality policy. As a result, the document can be protected. However, the document registered in the document management apparatus is not always in a finalized mode. For example, the mode of the document when registered in the apparatus may be differently set such that the document is merely registered prior to the editing process, currently subjected to the editing process, or have already been finalized after the completion of the editing process. Accordingly, a range of the users demanding the access to the document was different in accordance with each mode, which made it necessary to change the setting of the access right based on the mode every time when the mode was changed. As a result, a complicated operation was demanded when the setting was changed.

A main object of the present invention is to provide a document management apparatus capable of protecting a document in accordance with a mode thereof even after the document is no longer under the control of the document management apparatus without demanding any complicated operation by a user.

A document management apparatus according to the present invention includes:

a document management unit for managing a mode indicating a registration state of a registered document;

a rule management unit for managing a rule restricting a function that can be executed by a user in relation to the document;

a rule application unit for selecting the rule in accordance with the mode of the document; and

an encryption unit for encrypting the document based on the rule.

The document management apparatus may further include a signature addition unit for adding a signature to the document.

The document management apparatus may further include a document registration unit for requesting the document to be registered, wherein the rule application unit selects a rule for encrypting the document so that only a registered user can read and write the document as a rule corresponding to a registered mode set when the registration of the document is requested.

The document management apparatus may further include a document-mode change instruction reception unit for receiving an instruction for changing the mode of the document, wherein the rule application unit selects the rule in accordance with the changed mode.

The rule may be set with respect to each of a plurality of folders. Further, the rule may be set with respect to a file name.

The encryption unit may encrypt the document by means of a public key encryption method. The signature addition unit may add the signature by means of the public key encryption system.

The document may be a PDF document.

A document management apparatus according to the present invention includes:

a document management unit for managing a mode indicating a registration state of a registered document;

a rule management unit for managing a rule restricting a function that can be executed by a user in relation to the document;

a rule application unit for selecting the rule in accordance with the mode of the document; and

a signature addition unit for adding a signature to the document based on the rule.

A document management method according to the present invention includes:

selecting a rule restricting a function that can be executed by a user in accordance with a mode indicating a registration state of a registered document; and

encrypting the document based on the rule.

The document management method may further include:

managing a mode indicating a registration state of a registered document; and

managing a rule restricting a function that can be executed by the user in relation to the document.

The document management method may further include adding a signature to the document.

The document management method may be realized in the form of a document management program executed on a computer. In that case, a document management program executes a document management method including steps below on a computer:

selecting a rule restricting a function that can be executed by a user in accordance with a mode indicating a registration state of a registered document; and

encrypting the document based on the rule. The document management can be executed as described earlier when the document management program is executed on the computer. The document management program is not necessarily executed on MFP, but may be executed on a conventional computer not including a printing unit and a scanner unit.

The document management program may be recorded on a computer-readable recording medium.

According to the document management apparatus of the present invention, an appropriate access right can be automatically given in accordance with the respective operations with respect to the document even when the document is taken out of the document management apparatus. Further, a certification of who finally edited the document can be automatically given.

### BRIEF DESCRIPTION OF THE DRAWINGS

The present invention will become readily understood from the following description of preferred embodiments thereof made with reference to the accompanying drawings, in which like parts are designated by like reference numeral and in which:

FIG. 1 is a block diagram illustrating a physical configuration of a document management apparatus and a user terminal according to an first embodiment of the present invention;

FIG. 2 is a block diagram illustrating a functional configuration of the document management apparatus and the user terminal according to the first embodiment of the present invention;

FIG. 3 is a schematic view illustrating how folders and rules correspond to one another in a document management unit, a rule application unit and a rule management unit;

FIG. 4 is a flow chart of a document registration in the document management method according to the first embodiment of the present invention;

FIG. 5 is a flow chart of a document-mode change in the document management method according to the first embodiment of the present invention;

FIG. 6 is a flow chart of a document handling from inside a document management system in the document management method according to the first embodiment of the present invention;

FIG. 7 is a flow chart of a document handling from outside the document management system in the document management method according to the first embodiment of the present invention; and

FIG. 8 is a flow chart of a rule setting.

### DESCRIPTION OF THE PREFERRED EMBODIMENTS

Hereinafter, a preferred embodiment of the document management apparatus according to the present invention is described referring to the drawings. In the drawings, like components are substantively indicated by like references.

### First Embodiment

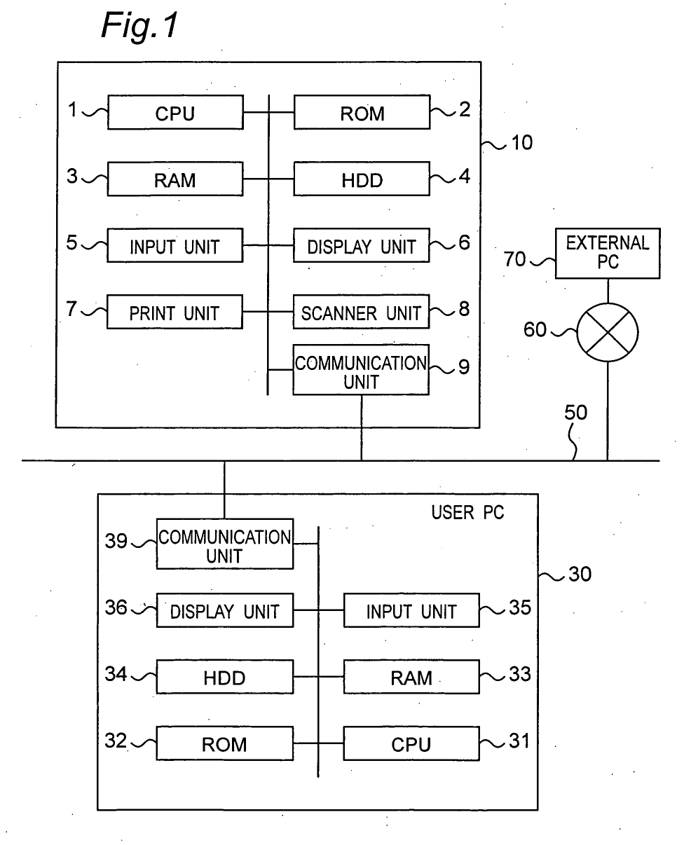

FIG. 1 is a block diagram illustrating a physical configuration of a document management apparatus 10 and a user terminal 30 according to an first embodiment of the present invention. The document management apparatus 10 includes a CPU 1, ROM 2, a RAM 3, a HDD 4, an input unit 5, a display unit 6, a printing unit 7, a scanner unit 8, and a communication unit 9. The user terminal 30 includes a CPU 31, a ROM 32, a RAM 33, a HDD 34, an input unit 35, a display unit 36, and a communication unit 39. The document management apparatus 10 and the user terminal 30 are connected to each other via a network 50. The document management apparatus 10 and the user terminal 30 connected to each other via the network 50 constitute a document management system. The document management apparatus 10 is further connected to an external PC 70 via an internet 60 or the like and can be accessed via the external PC 70. The document management apparatus 10 includes the printing unit 7 and the scanner unit 8 as in MFP, however, these components may be omitted. A conventional computer not including the printing unit 7 and the scanner unit 8 may be used to realize the document management apparatus 10.

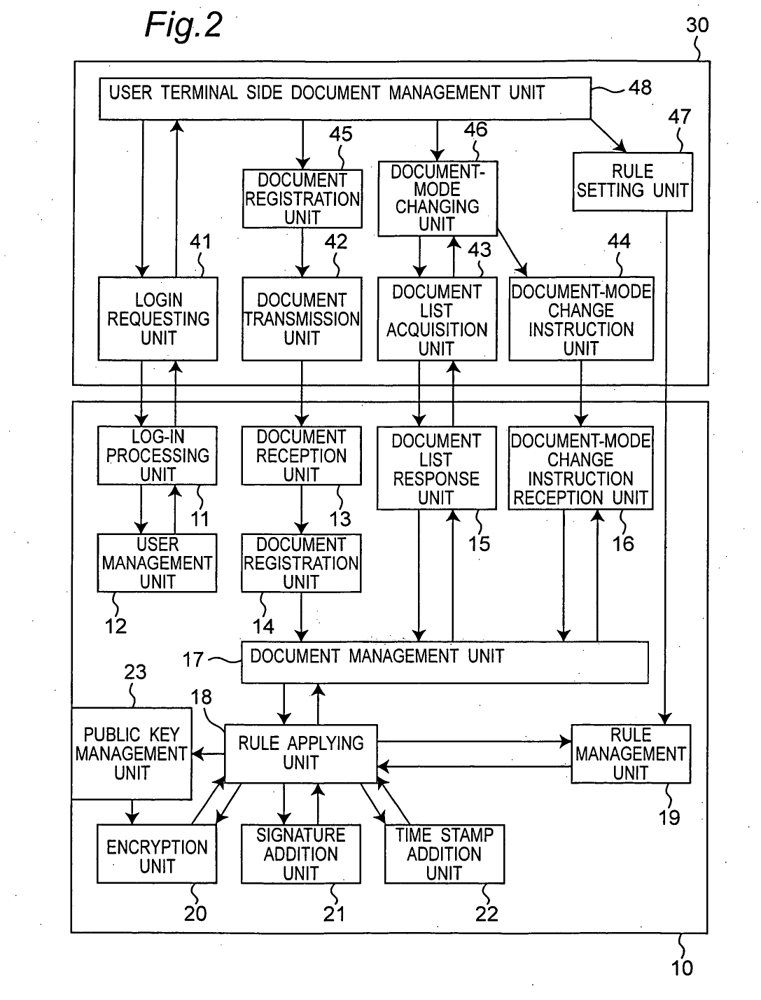

FIG. 2 is a block diagram illustrating a functional configuration of the document management apparatus 10 and the user terminal 30 according to the first embodiment of the present invention. The document management apparatus 10 includes a log-in processing unit 11, a user management unit 12, a document reception unit 13, a document registration unit 14, a document list response unit 15, a document-mode change instruction reception unit 16, a document management unit 17, a rule application unit 18, a rule management unit 19, an encryption unit 20, a signature addition unit 21, a time stamp unit 22, and a public key management unit 23. The log-in processing unit 11 accepts a log-in request from the user terminal 30. The user management unit 12 confirms whether or not a user who logged in is a registered user in response to an inquiry from the log-in processing unit 11. The document reception unit 13 receives a document transmitted from the user terminal 30. The document registration unit 14 delivers a request for registering the received document to the document management unit 17. The document list response unit 15 responds to a document list acquiring request from the user terminal 30 by providing a document list. The document-mode change instruction reception unit 16 accepts a document-mode change instruction. The document management unit 17 gives the document together with information to the rule application unit 18 in response to the document registration request. The rule application unit 18 makes an inquiry about a rule to be applied corresponding to a mode of the document to the rule management unit 19. The rule described here is a regulation for restricting a function that can be executed by the user in relation to the document. For example, the rule serves to encrypt the document so that the document can be read and written by only a specified user. The rule management unit 19 gives a response regarding the rule corresponding to the document mode. The encryption unit 20 encrypts the document based on the rule. The signature addition unit 21 adds a signature. The time stamp unit 22 adds a time stamp. The public key management unit 23 manages a public key per user as shown in Table 1.

TABLE 1
Public key management unit

| User Name | Public key |
|---|---|
| Daddy | **** |
| Tom | $$$$ |
| Jim | !!!! |
| Carry | #### |
| Bill | %%%% |
| Henry | &&&& |
| Mike | @@@@ |
| . | . |
| . | . |
| . | . |
| . | . |
| . | . |
| . | . |

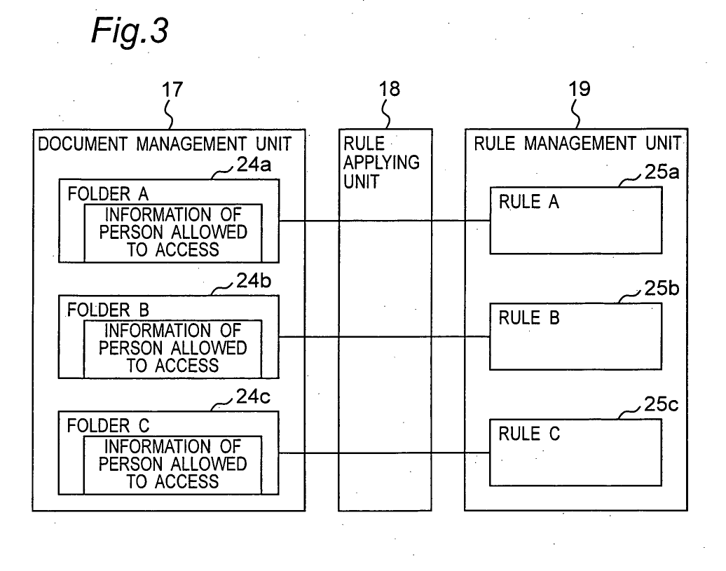

FIG. 3 is a schematic illustration of an exemplary case where rules 25a, 25b and 25c respectively corresponding to folders 24a, 24b and 24c are set in the document management unit 17, rule application unit 18 and rule management unit 19 of the respective components of the document management apparatus shown in FIG. 2. These rules define the respective users permitted to read and write the document for each mode indicating the registration state of the document as shown in Table 2 below. In the document management apparatus 10, the rule to be applied is selected for the mode set in the document, and the document is encrypted in accordance with the selected rule. Thereby, the rule to be applied to the changed rule is selected whenever the mode set in the document is changed. Therefore, for example, a group of users who are allowed to read and write the document can be replaced in accordance with the mode change.

TABLE 2

| | Rule A | Rule B | . . . |
|---|---|---|---|
| Registration | Encrypted so that | Encrypted so that | . . . |
| mode | document creator alone | document creator alone | |
| | can read and write | can read and write | |
| Editing mode | Encrypted so that | Encrypted so that | . . . |
| | document creator can | document creator and | |
| | read | document reader | |
| | Encrypted so that | can read | |
| | document editor can | Encrypted so that | |
| | read and write | document editor can | |
| | | read and write | |
| Public mode | Encrypted so that | Encrypted so that | . . . |
| | document reader alone | document reader alone | |
| | can read | can read | |
| User | Document creator: John | Document creator: Bill | . . . |
| | Document editor: Mike, | Document editor: Tom, | |
| | Henry, Scott | Chris, Carry | |
| | Document reader: | Document reader: all | |
| | person allowed to | of the users | |
| | access folder | | |

As shown in FIG. 2, the user terminal 30 includes a long-in requesting unit 41, a document transmission unit 42, a document list acquisition unit 43, a document-mode change instruction unit 44, a document registration unit 45, a document-mode changing unit 46, a rule setting unit 47, and a user-terminal side document management unit 48. The long-in requesting unit 41 makes a long-in request from the user terminal 30 to the document management apparatus 10. The document registration unit 45 selects a document to be registered. The document transmission unit 42 transmits the selected document to the document reception unit 13 of the document management apparatus 10. The document list acquisition unit 43 requests the acquisition of a document list with respect to the document management apparatus 10. The document mode changing unit 46 selects a document whose mode is to be changed from the acquired document list. The document-mode change instruction unit 44 transmits a mode change request of the selected document to the document management apparatus 10. The rule setting unit 47 sets a rule for restricting a function that can be executed by the user regarding the document in accordance with the document mode, and transmits the set rule to the rule management unit 19 of the document management apparatus 10. According to the user terminal 30, when the change of the mode to be set for the document is simply instructed, the document can be encrypted in accordance with a group of users who can read and write the document in the document management apparatus 10.

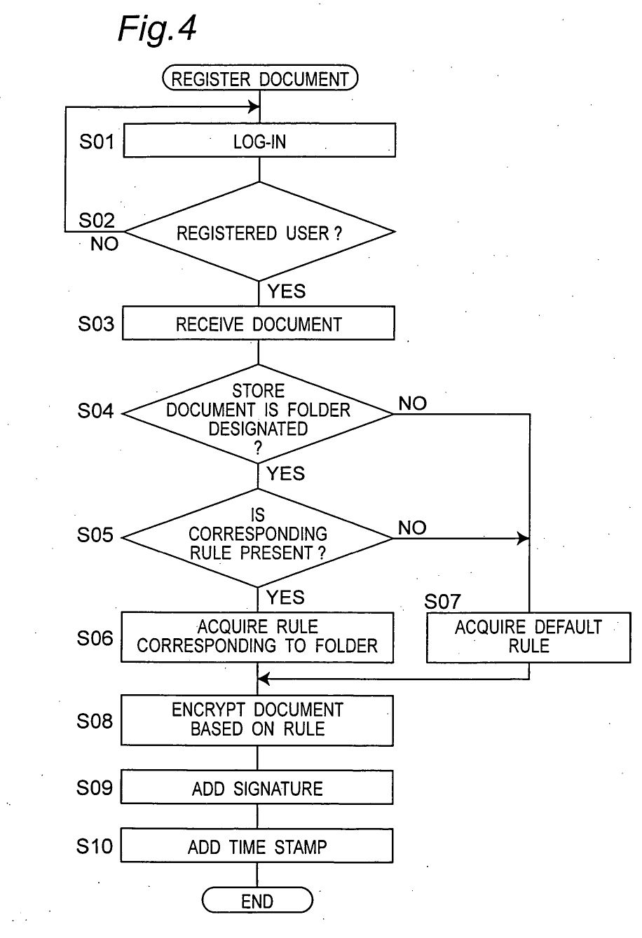

FIG. 4 is a processing flow chart of the “registration mode” in the document management method according to the first embodiment of the present invention.

a) The log-in is accepted (S01). The log-in request from the log-in requesting unit 41 of the user terminal 30 is accepted by the log-in processing unit 11.

b) It is judged whether or not the user who logged in is the registered user (S02). An inquiry is made to the user management unit 12 so as to confirm whether or not the logged-in user is the registered user. When the logged-in user is the registered user, the processing advances to a next step S03 upon the judgment that the log-in was successful. When the logged-in user is not the registered user, the log-in requesting unit 41 of the user terminal 30 is requested to try the log-in again and the processing goes back to the log-in acceptance upon the judgment that the log-in was unsuccessful.

c) The document transmitted from the user is received (S03). The document creator transmits the document from the document transmission unit 42 of the user terminal 30, and the document reception unit 13 of the document management apparatus 10 receives the transmitted document and delivers the document to the document registration unit 14. After that, the document registration request is transmitted from the document registration unit 14 to the document management unit. In the document, the “registration mode” is set by the document creator.

d) It is judged whether or not the storage folder is designated (S04). Then, various information (registered user's name, storage folder, registered file name, and the like) are transmitted together with the document to be registered from the document management unit 17 to the rule application unit 18. The rule application unit 18 makes an inquiry about the presence/absence of the rule to be applied to the rule management unit 19. When the storage folder is designated, the processing advances to a next step S05. When the storage folder is not designated, for example, a default rule shown in the following Table 3 is obtained (S07), and the processing advances to a next step S08.

e) The presence/absence of the rule corresponding to the storage folder is judged (S05). For example, in the example shown in FIG. 3, the rule A (25a) corresponds to the storage folder 24a. Then, the rule A (25a) shown in Table 2 is obtained (S06). In the absence of the corresponding rule, the default rule shown in Table 3 is obtained (S07). The default rule is not limited to the example shown in Table 3, and may be a rule for encrypting the document in such manner that the registered user can read and write the document with respect to all of the modes.

TABLE 3

| Document mode | Rule |
|---|---|
| Registration mode | Encrypted so that only document creator can |
| | read and write |
| | Document creator's signature is added |
| | Time stamp is added |
| Editing mode | Encrypted so that only document editor can |
| | read and write |
| | Document editor's signature is added |
| | Time stamp is added |
| Public mode | Encrypted so that only document reader can read |
| | Time stamp is added |

f) The document is encrypted based on the obtained rule (S08). The encryption process can be executed by the encryption unit 20. The rule corresponding to the “registration mode” in the example of the default rule shown in Table 3 is “encrypted so that only document creator can read and write, document creator's signature is added, time stamp is added”. Then, the document is encrypted so that only the document creator can read and write the document based on the rule. The document can be encrypted by means of a method of encrypting the document so that only the document creator can read and write the document based on the rule. For example, when the document creator's public key is used to encrypt the document according to a public key encryption method, the document creator alone can decode the encryption. Therefore, the document creator alone is allowed to read and write the document. The encryption method is not limited to the public key encryption method.

g) The document creator's signature is added (S09). The signature addition unit 21 can be used to provide the signature. For example, the public key encryption method may be used as the signature method. Further, the document may be simply provided with the signature without being subjected to the encryption process.

h) The time stamp is added (S10). The time stamp addition unit 22 can be used to add the time stamp. The addition of the time stamp enables time authentication to be realized. In the foregoing manner, the document management can be carried out in the registration mode for registering the document.

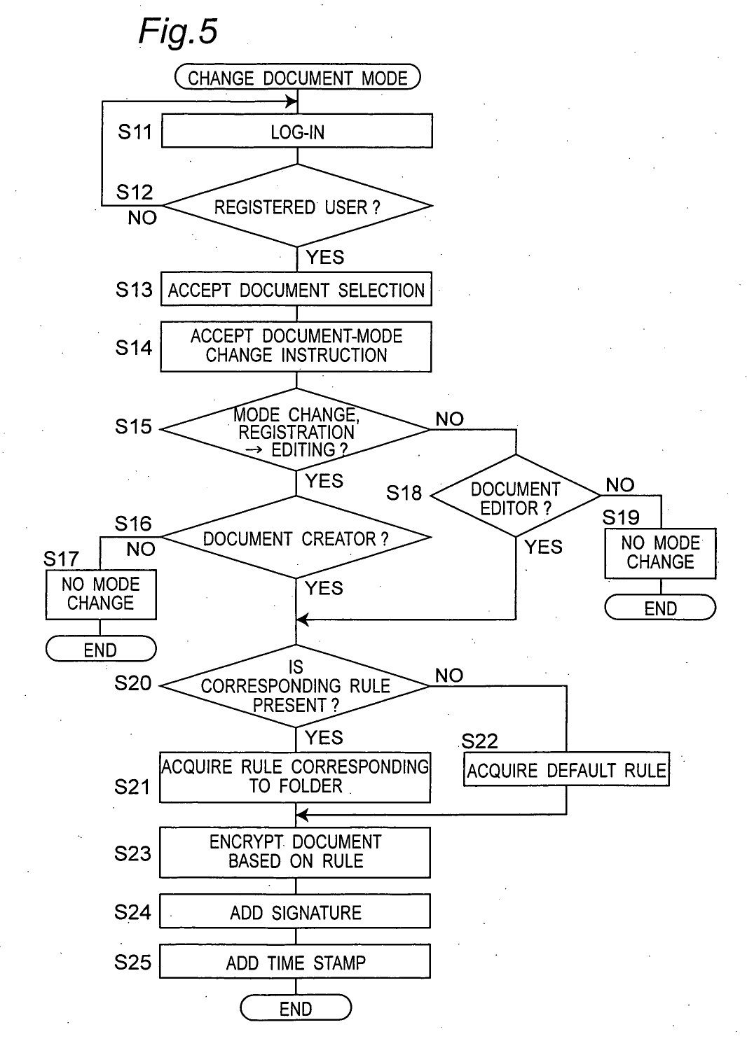

FIG. 5 is a flow chart of changing the document mode in the document management method according to the first embodiment of the present invention. To describe the change of the document mode, for example, the document mode is changed from the “registration mode” to the “editing mode”, or, from the “editing mode” to the “public mode”. The change of the document mode from the “registration mode” to the “editing mode” is instructed by the document creator. The change of the document mode from the “editing mode” to the “browsing mode” is instructed by the document editor.

a) The log-in is accepted (S11).

b) It is judged whether or not the user who logged in is a registered user (S12). When the logged-in user is the registered user, the processing advances to a next step S13 upon the judgment that the log-in was successful. When the logged-in user is not the registered user, the log-in is accepted again upon the judgment that the log-in was unsuccessful.

c) The selection of the document whose mode is to be changed is accepted (S13).

d) The document-mode change instruction is accepted (S14). In the present case, the document mode setting is changed from the “registration mode” to the “editing mode”. The change of the document mode from the “editing mode” to the “public mode” is not described here, however, is similarly processed.

e) It is judged whether or not the accepted mode change is “registration mode->editing mode” (S15). When the accepted mode change is “registration mode->editing mode”, the processing advances to a next step S16, while advances to a step S18 otherwise.

f) It is judged whether or not the user who logged in is the document creator (S16). When the logged-in user is the document creator, the document mode is changed as “registration mode->editing mode”, the processing advances to a next step S20. The document mode is not changed when the logged-in user is anyone but the document creator (S17), the processing is terminated.

g) When the mode change is not “registration mode->editing mode”, it is judged whether or not the logged-in user is the document editor (S18). When the logged-in user is the document editor, the document mode is changed as “editing mode->public mode”, and the processing advances to the next step S20. When the logged-in user is anyone but the document editor, the document mode is not changed (S19). Then, the processing is terminated.

h) The presence/absence of the corresponding rule is judged (S20). Then, various information (registered user's name, storage folder, registered file name, and the like) are transmitted together with the document whose mode is to be changed from the document management unit 17 to the rule application unit 18. The rule application unit 18 makes an inquiry about the presence/absence of the rule to be applied to the rule management unit 19. In the present case, the presence/absence of the rule corresponding to the storage folder is judged (S20). In the presence of the rule, the rule is obtained (S21). For example, the rule shown in Table 2 may be obtained. In the absence of the corresponding rule, the default rule shown in Table 3 is obtained (S22).

i) The document is encrypted based on the acquired rule (S23). The encryption process can be executed by the encryption unit 20. For example, the rule corresponding to the changed mode, for example, the “editing mode” is “encrypted so that document creator can read, encrypted so that document editor can read and write” in the rule A in the example shown in Table 2. Then, the document is encrypted based on the foregoing rule so that the registered “document creator” can read and the registered “document editor” can read and write the document. When the document mode is changed to the “public mode”, the rule corresponding to the “public mode” is “encrypted so that only document reader can read” in the example shown in Table 2. Based on the rule, the document is encrypted so that only the registered “document reader” can read the document.

j) The signature is added (S24). For example, the public key encryption method may be used to provide the signature. Further, the document may be simply provided with the signature without being subjected to the encryption process.

k) The time stamp is added (S25). The time stamp addition unit 22 can be used to add the time stamp.

In the foregoing manner, the document management can be carried out in response to the mode change of the document.

In the foregoing description, there are three examples of the document mode, that are the “registration mode”, “editing mode” and “public mode”, however, the document mode is not limited to the three modes. For example, “editing termination mode”, which indicates a state where the “editing” has been terminated, may be provided. According to the document management method, the document is encrypted in such manner that only the specific registered user can read and write or only read the document in accordance with the set mode, the signature is added whenever necessary, and the time stamp is added. For example, in the “registration mode”, the user who has registered the document is judged to be the “document creator”, and the document is encrypted so that only the document creator can read and write the document. In the “editing mode”, the document is encrypted so that the user registered as the “document creator” can read the document and the user registered as the “document editor” can read and write the document. The editing mode may be set in such manner that the user registered as the “document creator” cannot read and write the document unless he/she is also registered as the “document editor”. In the pubic mode, the document is encrypted so that only the user registered as the “document reader” can read the document. The public mode may also be set in such manner that the user registered as the “document creator” and the “document editor” cannot read and write the document unless he/she is also registered as the “document reader”.

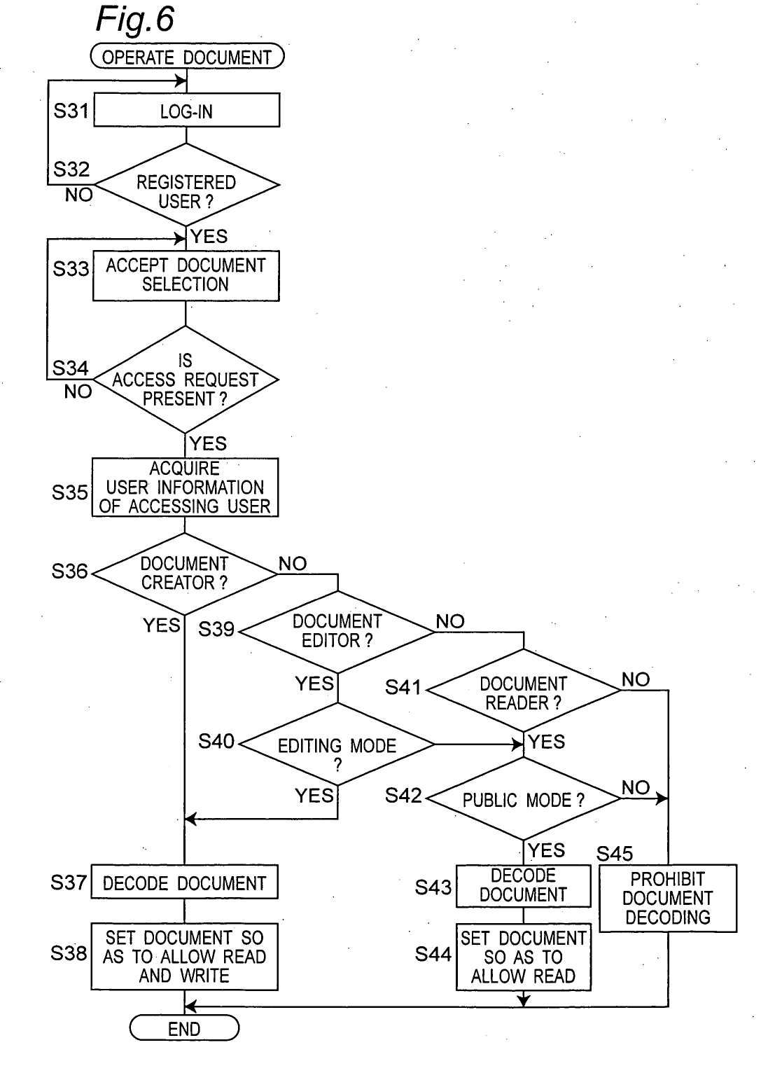

FIG. 6 is a flow chart when the user in the document management system operates the document in the document management method according to the first embodiment of the present invention.

a) The log-in is accepted (S31).

b) It is judged whether or not the user who logged in is the registered user (S32). When the logged-in user is the registered user, the processing advances to a next step S33 upon the judgment that the log-in was successful. When the logged-in user is not the registered user, the log-in is accepted again upon the judgment that the log-in was unsuccessful.

c) The selection of the document to be operated is accepted (S33).

d) The presence/absence of the access request is judged (S34). In the presence of the access request, the processing advances to a next step S35. In the absence of the access request, the selection of the document is accepted again.

e) A user information of the user who made the access is obtained (S35).

f) It is judged whether or not the user is the document creator (S36). When the user is the document creator, the processing advances to a next step S37. When the user is not the document creator, the processing advances to a step S39. In the present example, the “document creator” can access the document in any mode.

g) When the user is the document creator, the document is decoded (S37). Next, the document is set in such manner that the read and write are allowed (S38). Then, the processing is terminated.

h) It is judged whether or not the user is the document editor (S39). When the user is the document editor, the processing advances to a next step S30. When the user is not the document editor, the processing advances to a step S41.

i) It is judged whether or not the document mode is the editing mode (S40). When the document mode is the editing mode, the processing advances to the step S37, in which the document is decoded (S37). Next, the document is set in such manner that the read and write are allowed (S38), and the processing is then terminated. When the document mode is not the editing mode, the processing advances to a step S42.

j) It is judged whether or not the user is the document reader (S41). When the user is the document reader, the processing advances to the next step S32. When the user is not the document reader, the decoding of the document is prohibited (S45), and the processing is then terminated.

k) It is judged whether or not the document mode is the public mode (S42). When the document mode is the public mode, the document is decoded (S33). Then, the document is set in such manner that the browsing is allowed (S44). Then, the processing is terminated. When the document is not the public mode, the decoding of the document is prohibited (S45), and the processing is terminated.

In the foregoing manner, when the user in the document management system operates the document, only the specific user who is allowed to access the document can operate the document in accordance with the mode set in the document.

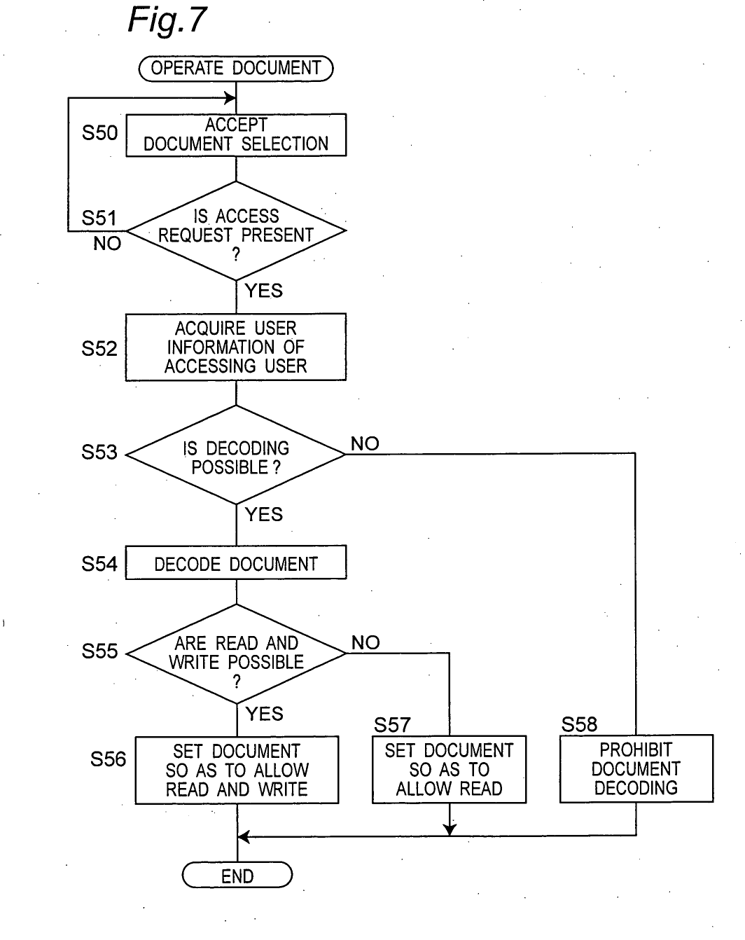

FIG. 7 is a flow chart when a user PC70 operates the document from outside of the document management system.

a) The selection of the document from the user PC70 is accepted in the document management apparatus 10 (S50).

b) The presence/absence of the access request is judged (S51). In the presence of the access request, the processing advances to a next step S52. In the absence of the access request, the processing goes back to the acceptance of the document selection.

c) The user information of the user who has made the access is obtained (S52).

d) It is judged whether or not the user is allowed to decode the selected document (S53). When the user is allowed to decode the document, the processing advances to a next step S54. When the user is not allowed to decode the document, the decoding of the document is prohibited (S58), and the processing is then terminated.

e) The selected document is decoded (S54).

f) It is judged whether or not the user is allowed to read and write the selected document (S55). When the user is allowed to read and write the document, the document is set in such manner that the read and write are allowed (S56). When the user is not allowed to write the document, the document is set in such manner that the browsing is allowed (S57), and the processing is then terminated. In the foregoing manner, the document operation by the user terminal 70 outside the document management system can be handled.

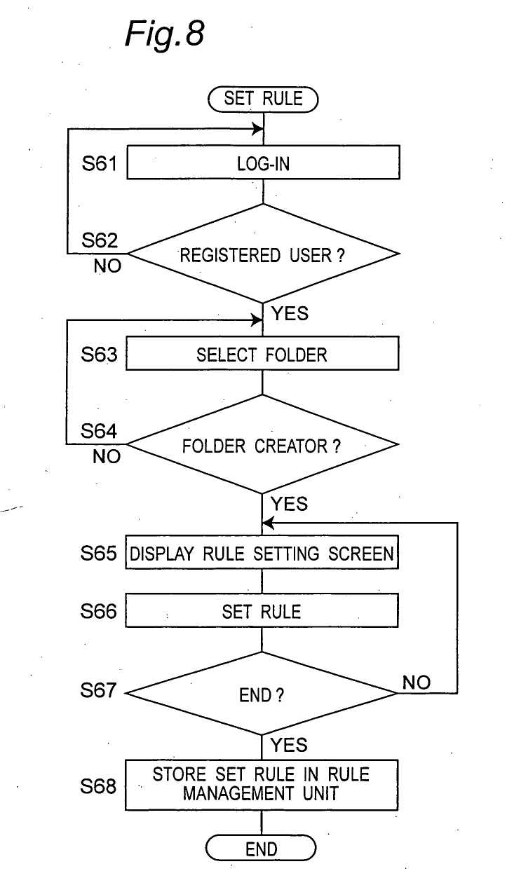

According to the document management method, the rule shown in Table 1 may be set in place of the default rule. Below is described a case where a folder creator sets the rule to be applied when the document is stored in the relevant folder. FIG. 8 is a flow chart of the rule setting.

a) The log-in is accepted (S61).

b) It is judged whether or not the user is the registered user (S62). When the user is the registered user, the processing advances to a next step S63. When the user is unregistered, the processing goes back to the step S61 in which the log-in is accepted.

c) The folder selection is accepted (S63).

d) It is judged whether or not the logged-in user is the folder creator (S64). When the logged-in user is the folder creator, the processing advances to a next step S65. When the logged-in user is not the folder creator, the processing goes back to the step S63 in which the folder selection is accepted.

e) A rule setting screen is displayed (S65).

f) The rule is set (S66).

g) It is judged whether not the processing is terminated (S67). When it is judged that the processing is terminated, the set rule is stored in the rule management unit 19 (S68), and then, the processing is terminated. When it is judged that the processing is not terminated, the processing goes back to the step S65 in which the rule setting screen is displayed.

In the foregoing manner, as shown in the example of FIG. 3, the rules 25a, 25b and 25c can be set in association with the folders 24a, 24b and 24c.

The document management method can be executed on a conventional computer not including the printing unit 7 and the scanner unit 8. Therefore, the document management method can be realized as a document management program that can be executed on the conventional computer.

The present invention can be effectively applied to a document management apparatus and a document management method for controlling a user's access right to a document.

Although the present invention has been described in connection with the preferred embodiments thereof with reference to the accompanying drawings, it is to be noted that various changes and modifications are apparent to those skilled in the art. Such changes and modifications are to be understood as included within the scope of the present invention as defined by the appended claims, unless they depart therefrom.

What is claimed is:

1. A document management apparatus comprising:
a document management unit for managing a mode indicating a registration state of a registered document;
a rule management unit for managing a rule restricting a function that can be executed by a user in relation to the document;
a rule application unit for selecting the rule in accordance with the mode of the document; and
an encryption unit for encrypting the document based on the rule.

2. The document management apparatus according to claim 1, further comprising a signature addition unit for adding a signature to the document.

3. The document management apparatus according to claim 1, further comprising a document registration unit for requesting the document to be registered,
wherein the rule application unit selects a rule for encrypting the document so that only a registered user can read and write the document as a rule corresponding to a registered mode set when the registration of the document is requested.

4. The document management apparatus according to claim 1, further comprising a document-mode change instruction reception unit for receiving an instruction for changing the mode of the document,
wherein the rule application unit selects the rule in accordance with the changed mode.

5. The document management apparatus according to claim 1, wherein the rule is set with respect to each of a plurality of folders.

6. The document management apparatus according to claim 1, wherein the rule is set with respect to a file name.

7. The document management apparatus according to claim 1, wherein the encryption unit encrypts the document by means of a public key encryption method.

8. The document management apparatus according to claim 2, wherein the signature addition unit adds the signature by means of a public key encryption method.

9. The document management apparatus according to claim 1, wherein the document is a PDF document.

10. A document management apparatus comprising:
a document management unit for managing a mode indicating a registration state of a registered document;
a rule management unit for managing a rule restricting a function that can be executed by a user in relation to the document;
a rule application unit for selecting the rule in accordance with the mode of the document; and
a signature addition unit for adding a signature to the document based on the rule.

11. A document management method comprising:
selecting a rule restricting a function that can be executed by a user in accordance with a registration state of a registered document; and
encrypting the document based on the rule.

12. The document management method according to claim 11, further comprising:
managing a mode which indicating a registration state of a registered document; and
managing a rule restricting a function that can be executed by a user in relation to the document.

13. The document management method according to claim 11, further comprising adding a signature to the document.

14. A document management program for executing a document management method including steps below on a computer, comprising:
selecting a rule restricting a function that can be executed by a user in accordance with a mode indicating a registration state of a registered document; and
encrypting the document based on the rule.

15. The document management program according to claim 14, further comprising:
managing a mode indicating a registration state of a registered document; and
managing a rule restricting a function executable by the user in relation to the document

16. The document management program according to claim 14, further comprising a step of adding a signature to the document.

17. A computer-readable recording medium in which the document management program recited in claim 14 is stored.
